(19) United States
(12) Patent Application Publication
(10) Pub. No.: US 2013/0079122 A1
(43) Pub. Date: Mar. 28, 2013

(54) CASHLESS CONTROLLER SYSTEM AND BOARD

(71) Applicant: NANOPTIX INC., Dieppe (CA)

(72) Inventors: Michel VIENNEAU, Dieppe (CA); Yvon HACHE, Dieppe (CA)

(73) Assignee: NANOPTIX INC., Dieppe (CA)

(21) Appl. No.: 13/685,143

(22) Filed: Nov. 26, 2012

Related U.S. Application Data
(63) Continuation of application No. 12/724,238, filed on Mar. 15, 2010, now abandoned.

(51) Int. Cl. G07F 17/32

(52) U.S. Cl. CPC G07F 17/3246; G07F 17/3225; G07F 17/3251
USPC 463/25; 463/42

(57) ABSTRACT

A controller board and system for converting a cash-based game machine to a cashless, wireless system employing wireless network connectivity is disclosed. The controller board consists of a circuit board, one or more emulation circuits, a serial interface, one or more switches and a microcontroller. The controller system consists of the controller board with the serial interface connected to a display and a card reader, and a wireless communication interface for communicating with the accounts server. Said one or more emulation circuits emulate the signals of cash-based peripherals on the game machine, once the peripheral cables are reconnected from the peripheral into the emulation circuit. The user's account is identified through the card reader and the user's account is debited or credited as a result of losing or winning gameplay by the microcontroller. Changes to the account balance are encrypted and sent to a casino server by means of the wireless interface.

### CROSS-REFERENCE TO RELATED APPLICATIONS

This application is a continuation of application Ser. No. 12/724,238 filed Mar. 15, 2010 which claims priority from application Ser. No. 60/160,133 filed Mar. 13, 2009, the disclosure of which is incorporated herein in its entirety by reference.

### FIELD OF THE INVENTION

The present invention relates generally to casino game machines and specifically a system and board to convert cash-based game machines to operate on a cashless basis.

### BACKGROUND OF THE INVENTION

Cash has long been a cause for inefficiency and lost income in the gaming industry, in particular with respect to slot and other gaming machines. Counting and verifying all the cash and coins is troublesome for casinos, let alone players who receive their winnings as cash from a machine. The costs of handling cash reduce a casino's profitability by increasing operating costs significantly. The time required by a player to insert cash into a machine also reduces the pull frequency of the machine. Many coins are normally needed within the slot machine as change and for wins, which traditionally have been paid out directly by the slot machine. Carrying a substantial amount of cash is a security risk for players, particularly in the case of a large win.

Casinos are switching to cashless systems which allow a player to maintain an account, on a card for instance, which allows said player to move from game machine to game machine, maintaining his or her own card balance at all times while playing, with winnings automatically added to the balance and bets deducted from the balance. At the end of a play session, the player may cash out the entire balance of winnings at once or have it directly deposited into a bank account. The elimination of coins and tokens obviates the need for removing coins from the slot machine, transporting them to the counting room, counting or weighting them, wrapping or bagging the coins, transporting them to the vault and issuing them to the cashiers.

Cashless game machines have existed for some time. However, casinos often have many legacy cash-based game machines that are operational, which they are forced to discard once they upgrade to cashless game machines, due to a shortage of space on the casino floor. This waste of otherwise operational machines could be avoided if existing cash-based game machines could be converted to operate on a cashless basis. However, there are a number of barriers to an easy conversion of game machines to cashless basis.

Many slot machines have built-in peripherals for accepting cash such as coin acceptors, bill acceptors and coin hoppers. These slot machines also have security measures within that disable the unit if the peripherals are not operational, by both reporting an error and preventing the machine from entering game play. The security measures attempt to detect all peripherals, such as cash acceptors, and determine if they are connected and working properly by requesting a signal of the peripheral that indicates its operational condition.

Because of these security measures, among other complications, it has not been practical and cost-effective in the past to upgrade a slot machine to work on a cashless basis, and casinos are often forced to replace otherwise functional machines with new machines that are designed and manufactured to allow play on a cashless basis.

Cash-based game machines are wired only to a power outlet which provides power to the machine for the game-playing experience and rarely is there any network connection between the game machines. A cashless game machine requires some means of communicating with the server which holds the account data. Such a link would generally consist of CAT-5 cabling throughout the casino forming a local area network. As wiring a large space with CAT-5 cable is unsightly and expensive, a secure wireless network is the preferred means of communication with the account server.

U.S. Patent Application No. 2008/0,313,636 discloses an automated data collection having an endpoint that collects data regarding a gaming machine, which endpoint then sends data back to a concentrator. The concentrator amalgamates signals to be sent to a remote collection server, wherein the data is pushed from the endpoint to the remote collection server at predetermined intervals, permitting data to be amalgamated from the gaming machines to the server. However said patent application does not disclose how to upgrade existing gaming machines for the use of a cashless system.

Based on the above there is a need for a device that converts existing cash-based casino game machines to cashless game play, that employs wireless connectivity with the accounts server to exchange encrypted account data.

### SUMMARY OF THE INVENTION

A controller board and system for converting a cash-based game machine to a cashless, wireless system employing wireless network connectivity is disclosed. The controller board consists of a circuit board, one or more emulation circuits, a serial interface, one or more switches and a microcontroller. The controller system consists of the controller board with the serial interface connected to a display and a card reader, and a wireless communication interface for communicating with the accounts server. Said one or more emulation circuits emulate the signals of cash-based peripherals on the game machine, once the peripheral cables are reconnected from the peripheral into the emulation circuit. The user's account is identified through the card reader and the user's account is debited or credited as a result of losing or winning gameplay by the microcontroller. Changes to the account balance are encrypted and sent to a casino server by means of the wireless interface.

### BRIEF DESCRIPTION OF THE DRAWINGS

It will now be convenient to describe the invention with particular reference to one embodiment of the present invention. It will be appreciated that the figures relate to one embodiment of the present invention only and are not to be taken as limiting the invention.

FIG. 1 is a functional diagram of the cashless controller board, according to one embodiment of the present invention;

FIG. 2 is a circuit diagram of the cashless controller board, according to one embodiment of the present invention; and

FIG. 3 is a photo of the cashless controller board, according to one embodiment of the present invention.

### DETAILED DESCRIPTION OF THE DRAWINGS

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

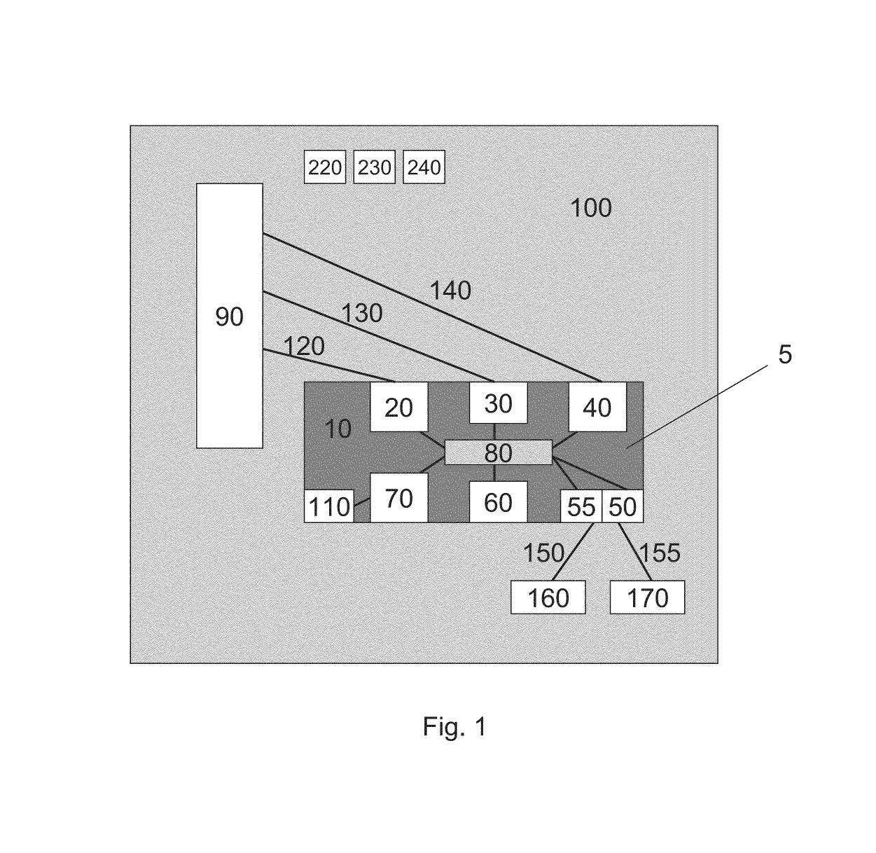

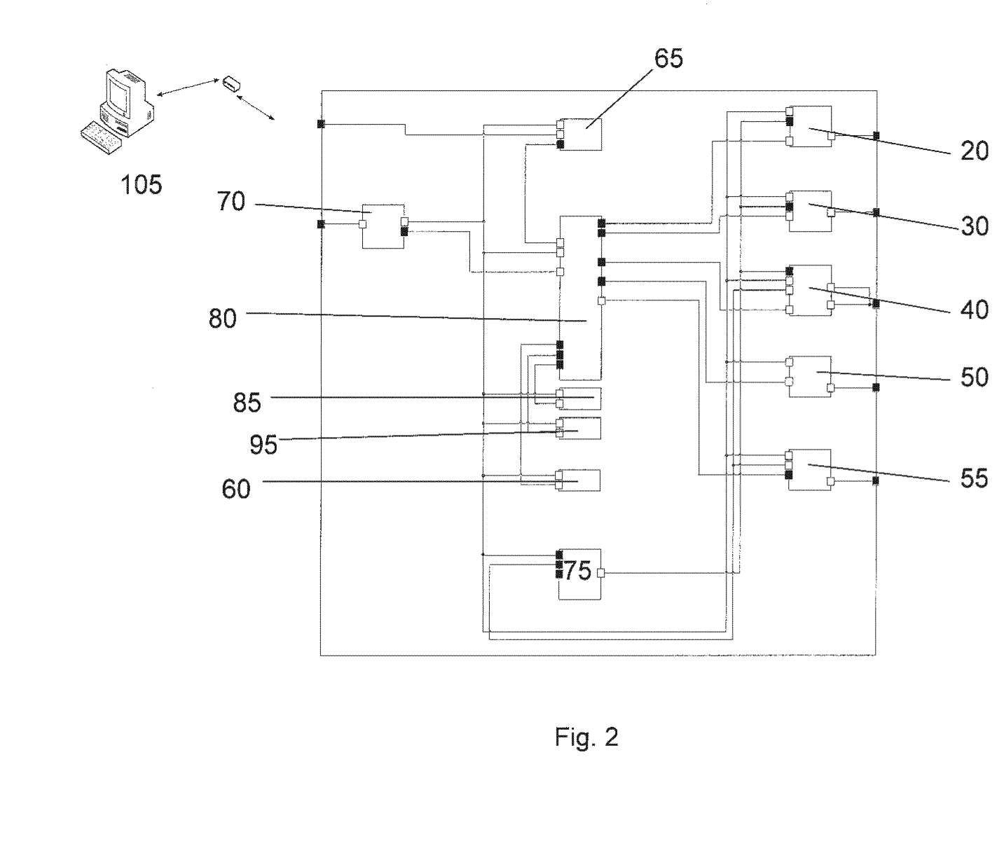

With reference to FIGS. 1 and 2, and according to one embodiment of the present invention, the cashless controller board 5 is shown within the game machine 100. The cashless controller board 5 consists of a printed circuit board 10, one or more emulation circuits, each for a cash acceptor, specifically according to the present embodiment, a coin hopper emulation circuit 20, a coin mechanism emulation circuit 30, a bill acceptor emulation circuit 40. The cashless controller board 5 also comprises an interface such as a serial port interface 50 and card reader interface 55, one or more switches such as a series of dual in-line package (DIP) switches 60 and a microcontroller 80. A cashless controller system, also disclosed, comprises the cashless controller board in addition to a card scanner 160, which is connected to card reader interface 55, and a display 170, which allow interaction with a player and is connected to the serial port interface 50, and a network interface, in this embodiment a wireless communication interface 70, which enables the cashless controller system to communicate with the accounts server.

The coin hopper emulation circuit 20, the coin mechanism emulation circuit 30, the bill acceptor emulation circuit 40, the serial port interface 50, the card reader interface 55, the series of dual in-line package (DIP) switches 60, and the wireless communication interface 70 are all connected through the printed circuit board 10 to the microcontroller 80. The microcontroller 80 processes input signals from, and produces output signals to, each of the emulation circuits 20, 30, 40, the serial port interface 50, the card reader interface 55, the switches 60 and the wireless communication interface 70. One skilled in the art would appreciate that the serial port interface is not limited herein, and may consist of any one of many standards, such as RS-232, infrared or USB, among others. One skilled in the art would also appreciate that the one or more switches 60 may be embodied in a different means, such as through software or stored as data values in flash memory, for example.

The coin hopper emulation circuit cable 120 is connected to the coin hopper emulation circuit 20 by means of a coin hopper emulation interface (not shown). The other end of the coin hopper emulation circuit cable 120 is connected to the game controller 90. Similarly, the coin mechanism emulation circuit cable 130 is connected to the coin mechanism emulation circuit 30 by means of a coin mechanism emulation interface (not shown). The other end of the coin mechanism emulation circuit cable 130 is connected to the game controller 90. The bill acceptor emulation circuit cable 140 is connected to the bill acceptor emulation circuit 30 by means of the bill acceptor emulation interface (not shown). The other end of the bill acceptor emulation circuit cable 140 is connected to the game controller 90. The card scanner interface 55 is connected by means of the card scanner cable 150 to the card scanner 160, which is mounted on the outside of the game machine 100. The serial port interface 50 is connected by means of the display cable 155 to the display 170, which is also mounted on the outside of the game machine 100, and may consist of an LCD screen with a character- or graphical-display capability. The wireless communication interface 70 is connected to a wireless communication transmitter 110, located on the board 10, which allows for the encrypted transfer of data to a casino's server.

With further reference to FIG. 1, and according to one embodiment of the present invention, the microcontroller 80 receives all input signals sent into the cashless controller board 5 by the emulation circuits 20, 30, 40, serial port interface 50, card reader interface 55, and wireless communication interface 70, and send output signals that are sent out of the cashless controller board 5 through the serial port interface 50 and the wireless communication interface 70. By the setting of the DIP switches 60, the microcontroller 80 is informed how to respond to the various checks sent out by the game controller 90 into the emulation circuits 20, 30, 40. The microcontroller 80 responds by means of the emulation circuit 20, 30, 40 to the game controller 90.

The hopper emulation circuit 20 simulates the presence of a coin hopper 220 to the game controller 90. The hopper emulation circuit 20 is connected to the game controller 90, which controls the game functionality, by means of the coin hopper cable 120. The game controller 90, present within a game machine 100 to control the operation of said machine, requires a series of checks to be satisfied, including a check that a coin hopper 220 exists and is functional, before the game controller 90 permits the game to be played. In an unmodified cash-based game machine, the game controller 90 would send a signal to the coin hopper 220 in order to engage in these checks, and the coin hopper 220 would send a corresponding signal to the game controller 90 that it exists and is operational. In an unmodified cash-based game machine, the game controller 90 would then be satisfied that the coin hopper 220 is operational, and given that the other systems were similarly operational, the game controller 90 would permit the game to be played. In the converted cashless game machine, once the cashless controller board 5 is within the game machine 100, the hopper cable 120 that once connected the game to the coin hopper 220 is now rewired to connect the controller board 5 with the game machine 100. The game machine 100 then sends a request to the microcontroller 80 by means of the coin hopper cable 120, which responds with a signal that the coin hopper 220 exists and is operational, and so satisfies the game controller. The game controller 90, satisfied that the coin hopper 220 is operational, enters game play mode and permits the game to be played.

The coin mechanism emulation circuit 30 is connected to the game controller 90 by means of the coin mechanism cable 130. The coin mechanism emulation circuit 30 also sends the same signal that the coin mechanism 230 of an unmodified cash-based game machine would otherwise have sent to the game controller 90. The microcontroller 80, through the coin mechanism emulation circuit 30, sends to the game controller 90 the correct signature that an existing and operational coin mechanism 230 would have sent to the game controller 90 in the case of a cash-based game machine, effectively satisfying the game controller that an existing and operational coin mechanism 230 is present. The game controller 90, once satisfied that its systems are in order, enters player mode, which allows a player to play the game.

Similarly, the bill acceptor emulation circuit 40 simulates the presence of an operational bill acceptor 240, even though in the converted cashless game machine 100 the bill acceptor 240 is no longer connected to the game controller. The bill acceptor emulation circuit 40 is connected to the game controller 90 by means of the bill acceptor cable 140. The game controller 90 sends a request to the bill acceptor emulation circuit 40, by means of the bill acceptor cable 140. The microcontroller 80 sends a signal back to the game controller 90 through the bill acceptor emulation circuit 40 indicating that the bill acceptor 240 is operational, satisfying the game controller 90 that its peripherals are operational, which then enters game play.

The microcontroller 80 may also send additional signals through the emulator circuits 20, 30, 40 depending on the requirements for a particular model of game machine. For example, after a game has been played the microcontroller 80 may send a signal to the game controller 90 that a new coin has been received and therefore the game controller now permits the game machine 100 to be played once again. The microcontroller 80 also receives information about the result of the game played from the game controller 90, so that the microcontroller 80 knows to credit or debit the player's account before the next play. This account information is then transmitted in encrypted format through the wireless communication interface 70 to the accounts server.

The card scanner interface 55 is connected to the card scanner 160 by means of the card scanner cable 150. The serial port interface 50 is connected to the display 170 by means of the display cable 155. The card scanner 160 mounted on the outside of the game machine 100, whereby the player may scan a card (not shown) containing the player information and inform the game machine 100 that a unique player is now playing at the game machine 100, and that they unique player's account should be used for that game-playing session. The player may also see his or her balance as well as promotional materials, for instance, on the display 170. When the cashless controller board 5 later connects with the account server (not shown) by means of the wireless communication interface 70, the account of the player is then debited by the amount of each bet, and credited with any winnings.

A series of dual in-line package (DIP) switches 60 is present on the board 10, which DIP switches 60 may be switched by a technician installing the cashless controller board 5 to correspond with a particular model of game machine 100. A certain setting of the DIP switches 60 indicates to the microcontroller 80 the necessary signal to be sent, in response to a request from the game controller, through the coin hopper emulation circuit 20, the coin mechanism emulation circuit 30 and the bill acceptor emulation circuit 40 in order to satisfy the game controller that the coin hopper 220, coin mechanism 230 and bill acceptor 240 exist and are in an operational state. The DIP switches 60 are typically set only once, at the time of installation into the game machine, and then no longer require any maintenance. The switch setting is based on the model of game machine 100 that the cashless controller board 5 is installed into. Should the cashless controller board 5 be used again in a different model of game machine, the DIP switches 60 may be reset for the new game machine, so the microcontroller 80 is informed of the model of the game machine, and is able to instruct the emulation circuitry to satisfy the game controller 90.

The wireless communication interface 70 communicates the player account balances and other game machine activity to the server through a wireless communication transmitter 110, such as a board-mounted XBee™ 802.15.4 RF module, which permits a relatively fast data transmission rate and 128-bit encryption. Such a wireless communication link with the server permits facilitated installation that does not require new wiring to be installed in the casino. The cashless controller board 5 may be installed in the game machine 100 wherever the game machine 100 is located on the casino floor, and the signal is wirelessly transmitted to the server. The wireless transmitter 110 is capable of encrypting the signal with 128-bit or higher security, in order to ensure data integrity and security with regards to the transferred data.

The cashless controller board also contains a program interface 65 and a power supply 75, as well as an EEPROM 85 and Status LED for diagnostics 95. A computer 105 may optionally be connected to program or reset the board, or to perform diagnostics.

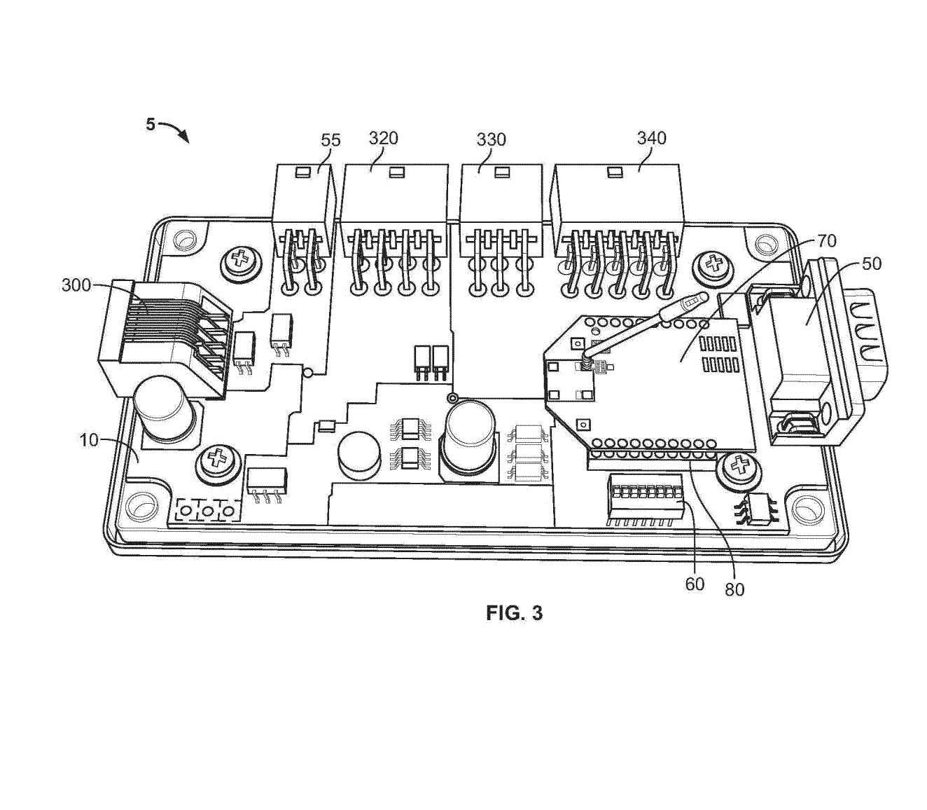

With reference to FIG. 3, a photo of the assembled cashless controller board 5 is shown. In this embodiment, the board 5 comprises a printed circuit board 10, serial interface 50, card scanner interface 55, DIP switches 60, wireless communication interface 70 with a microprocessor 80 below it, connected to the printed circuit board 10. The photo also shows an Ethernet connection 300, which is able to function as an alternative for the wireless communication interface 70, which is wired onto the printed circuit board 10. At the edge of the printed circuit board 10 a coin hopper emulation interface 320, a coin mechanism emulation interface 330 and a bill acceptor emulation interface 340 are all shown. It is into these interfaces that the coin hopper emulation circuit cable 120, a coin mechanism emulation circuit cable 130 and a bill acceptor emulation circuit cable 140.

Many modifications and other embodiments of the invention will come to the mind of one skilled in the art having the benefit of the teachings presented in the foregoing description and associated drawings. Therefore, it is understood that the invention is not to be limited to the specific embodiment disclosed, and that modifications and embodiments are intended to be included within the scope of the appended claims.

The embodiments of the invention in which an exclusive property or privilege is claimed are defined as follows:

1. A system for converting a game machine having one or more cash acceptors to cashless game play, comprising:
a) a board assembly comprising
i) a printed circuit board;
ii) a microcontroller;
iii) a network adapter adapted to communicate with a network;
iv) a card scanner interface; and
v) one or more emulation circuits adapted to emulate signals from the one or more cash acceptors; and
b) a card scanner electronically connected to said card scanner interface wherein said board assembly and said card scanner are connected to the game machine, and said card scanner interface is adapted to communicate with said card scanner.

2. The system of claim 1, said circuit board further comprising one or more switching means which are adapted to being switched in a configuration, which configuration is related to a specific model of game machine.

3. The system of claim 2, wherein said switching means is a dual in-line package switch.

4. The system of claim 1, wherein said one or more cash acceptors further comprise a coin hopper, a coin mechanism and a bill acceptor, and said one or more emulation circuits further comprise a coin hopper emulation circuit that is adapted to emulate signals sent and received by a coin hopper, a coin mechanism emulation circuit that is adapted to emulate signals sent and received by a coin mechanism, and a bill acceptor emulation circuit that is adapted to emulate signals sent and received by a bill acceptor.

5. The system of claim 1, said circuit board further comprising a serial port adapted to transmitting a signal to a display screen of the game machine.

6. The system of claim 1, wherein said network interface performs wirelessly.

7. The system of claim 6, wherein said wireless communication interface uses an 802.11 wireless standard.

8. A board assembly for converting a game machine to cashless game play, comprising:
i) A printed circuit board;
ii) a microcontroller;
iii) a network adapter adapted to communicate with a network;
iv) one or more emulation circuits adapted to emulate signals from the one or more cash acceptors; and
v) a card scanner interface which is adapted to communicate with a card scanner, wherein said microcontroller, said network adapter, said one or more emulation circuits, and said card scanner are all connected to said printed circuit board.

9. The system of claim 8, said circuit board further comprising one or more switching means which are adapted to being switched in a configuration, which configuration is related to a specific model of game machine.

10. The system of claim 9, wherein said switching means is a dual in-line package switch.

11. The system of claim 8, said circuit board further comprising a serial port adapted to transmit a display signal.

12. The system of claim 8, wherein said one or more cash acceptors further comprise a coin hopper, a coin mechanism and a bill acceptor, and said one or more emulation circuits further comprise a coin hopper emulation circuit that is adapted to emulate signals sent and received by a coin hopper, a coin mechanism emulation circuit that is adapted to emulate signals sent and received by a coin mechanism, and a bill acceptor emulation circuit that is adapted to emulate signals sent and received by a bill acceptor.

13. The system of claim 8, wherein said network interface performs wirelessly.

14. The system of claim 13, wherein said wireless communication interface uses an 802.11 wireless standard.
